(19) United States
(12) Patent Application Publication
(10) Pub. No.: US 2016/0063625 A1
(43) Pub. Date: Mar. 3, 2016

(54) AUTOMATED ENERGY BROKERING

(71) Applicant: Nextility, Inc., Washington, DC (US)

(72) Inventors: Zachary Arthur Axelrod, Washington, DC (US); Brian Mathews Gottlieb, Washington, DC (US); Daniel J. Sullivan, Silver Spring, MD (US); Stuart Richard Andrews, Rockville, MD (US); Dan Klothe, Bethesda, MD (US); Tom Melling, Sammamish, WA (US)

(21) Appl. No.: 14/805,440

(22) Filed: Jul. 21, 2015

Related U.S. Application Data
(60) Provisional application No. 62/044,915, filed on Sep. 2, 2014.

(51) Int. Cl. G06Q 40/04; G06Q 50/06

(52) U.S. Cl. CPC G06Q 40/04; G06Q 50/06

(57) ABSTRACT

A facility for automated energy brokering on behalf of an energy customer of the first energy supplier is described. The facility analyzes at least one bill issued to the energy customer on behalf of the first energy provider to determine terms of a current energy purchase arrangement of the energy customer. The facility obtains pricing information for a plurality of second energy suppliers each different from the first energy supplier. The facility identifies one of the second energy suppliers is more favorable to the energy customer than the first energy supplier. The facility enables the consolidation of a group of energy customers to obtain additional savings from energy suppliers. The facility also enables energy bills to be audited for errors.

### CROSS-REFERENCE TO RELATED APPLICATION

This application claims the benefit of U.S. Provisional Application No. 62/044,915, filed on Sep. 2, 2014, which is hereby incorporated by reference in its entirety.

### BACKGROUND

In a state in which the sale of energy (e.g., electricity and/or natural gas) has been deregulated, buyers of energy are free to choose any of a large number of severs operating in their state. The buyer pays the seller for the energy, and pays a distribution utility serving his location for delivering the energy from the seller to the buyer. The buyer also pays a variety of tariffs and other taxes imposed by government taxing authorities. The buyer typically receives a single bill from its distribution utility listing charges due to each the distribution utility, the seller, and the taxing authorities. The distribution utility typically receives payment of the whole bill from the buyer, and remits the seller's portion to the seller and taxing authorities. If the buyer fails to select a seller, a default seller is typically selected for the buyer by the distribution utility. In many cases, the distribution utility serves as its own default seller.

### BRIEF DESCRIPTION OF THE DRAWINGS

FIG. 1 is a block diagram showing some of the components typically incorporated in at least some of the computer systems and other devices on which the facility operates.

FIG. 2 is flow diagram showing steps typically performed by the facility in some embodiments in order to process a new bill received or retrieved for a particular energy buyer.

FIG. 3 is a document diagram showing a sample bill to be verified.

FIG. 4 is a flow diagram showing steps typically performed by the facility in some embodiments in order to estimate the proper amount of certain charges for a particular power buyer for a particular billing period.

FIG. 5 is a document diagram showing a sample bill corresponding to the first entry of the sample bill corpus table shown in Table 2.

FIG. 6 is a flow diagram showing steps typically performed by the facility in order to maintain current copies of matrix quotes for each energy seller that summarize the terms on which the seller sells energy to different classes of customers.

FIG. 7 is a document diagram showing a matrix quote retrieved by the facility from a particular seller.

FIG. 8 is a flow diagram showing steps typically performed by the facility in order to determine whether a particular buyer should switch from its current seller to a new seller.

FIG. 9 is a document diagram showing a sample custom quote obtained by the facility from a seller for a buyer.

FIG. 10 is a document diagram showing a sample solicitation sent by the facility in some embodiments to recommend to a particular buyer that it switch to a different seller.

FIG. 11 is a document diagram showing a sample scorecard document sent by the facility in some embodiments to a buyer to indicate how much the buyer has saved based upon having switched to the buyer's current seller based upon the facility's operation.

FIG. 12 is a flow diagram showing steps typically performed by the facility in some embodiments to assemble a custom group a buyers matching a seller's target consumption profile.

FIG. 13 is an energy profile diagram showing a target consumption profile specified by a first seller.

FIG. 14 is an energy profile diagram showing the consumption profile of a first buyer included in the first group.

FIG. 15 is an energy profile diagram showing the consumption profile of a second buyer included in the first group.

FIG. 16 is an energy profile diagram showing the collective consumption profile of the first and second buyers, i.e., the first group of buyers.

FIG. 17 is an energy profile diagram showing the consumption profile for a first buyer in the second group.

FIG. 18 is an energy profile diagram showing a consumption profile for a second buyer in the second group.

FIG. 19 is an energy profile diagram showing the consumption profile for a third buyer in the second group.

FIG. 20 is an energy profile diagram showing the collective consumption profile for the second group of buyers.

### DETAILED DESCRIPTION

The inventors have recognized that it can be difficult and/or time consuming for an energy buyer in a deregulated energy market to determine which seller to purchase energy from, especially for less sophisticated buyers with little visibility into the local energy market. Each seller is free to establish its own pricing structure, which can be complex. For example, a particular seller's pricing structure may be tiered to establish different rates for varying levels of consumption; may be phased to establish different rates during different date ranges, seasons, and/or ranges of weather conditions; etc. Also, the taxes paid to taxing authorities can vary based on the seller selected by the buyer. For example, certain taxes can be computed based upon the rate or total amount charged by the selected seller.

Buyers who regularly consume very large quantities of energy, such as very large office buildings and industrial buildings, have an opportunity to hire a conventional energy broker who uses manual processes and human domain knowledge to periodically identify opportunities to save money and/or reduced price risk by switching energy sellers. Energy brokers provide a service to energy buyers, such as finding the lowest cost of energy; in return, the broker receives a commission, which is typically paid by the energy supplier. However, the inventors have noted that such brokers tend to assist only buyers who consume very large quantities of energy, based on the high level of cost the brokers incur in providing this service, and thus are not available to buyers of more modest quantities of energy.

There are additional barriers that prevent small to mid-sized buyers of energy from achieving energy cost savings enjoyed by very large buyers. These buyers, or the brokers who would represent them, typically do not have the resources to check the price sheets that are published every day by energy sellers. Without automation, daily price optimization is not available to smaller energy buyers.

Using quasi-auctions to obtain price discounts is also not available. Very large buyers, or brokers for very large buyers, can obtain cost reductions by contacting multiple energy sellers and ask for custom price quotes, essentially conducting a mini-auction amongst multiple energy sellers. Energy sellers are willing to provide custom price quotes below their standard published rates because of the volume of energy to be purchased by a very large buyer (typically 5,000 megawatt hours (MWh) per year or greater). However, energy sellers will generally not provide custom price discount to a small- to mid-sized energy buyer because the buyer is too small to justify the time and expense of calculating a custom price discount.

Brokers have also had limited success consolidating a group of small- to mid-sized energy buyers such that the group has a sufficient energy consumption (e.g, collectively greater than 5000 MWh per year) to facilitate obtaining custom price discounts through conducting a quasi-action. It is difficult to consolidate such a group for several reasons. First, it requires a significant amount of manual work to identify, contact, and contract with a sufficient number of customers that have contracts expiring at the same time so that each energy buyer can switch to a new energy seller. Also, brokers may use organizations such as the chamber of commerce to find a group of energy buyers, but that limits the field of potential energy buyers. Moreover, organizations created for various purposes may not have a group of energy buyers that are optimized to create the greatest value for energy sellers. Finally, once an energy seller provides a custom price quote, the energy buyers have to execute a contract in a limited period of time (e.g. within 1 day), in which case the manual process of getting enough of the interested energy buyers to execute is difficult, and if a sufficient number of energy buyers fail to execute the contracts then the custom price quote expires.

Another barrier faced by small- to mid-sized energy buyers is confusing information in the marketplace. For example, some individual sellers employ marketing teams that attempt to persuade buyers who are buying from other sellers that their energy bills would be lower if they switched to the seller employing the marketing team. However, the inventors have noted that this technique does little to ensure that buyers receive the lowest price available to them from any seller. Moreover, sometimes energy sellers will offer a very low price but only for a short period of time, after which the energy seller increases the price significantly.

While deregulated energy markets hold the promise of driving down the cost of energy, structural, financial, and resource barriers make the benefits of deregulated markets much less attainable by small- to mid-sized energy buyers. Consequently, in many deregulated markets, a majority of small- to mid-sized energy buyers never change from the distribution utility's standard offer service (SOS), which is set by utility commissions and is often not the lowest cost of energy. Thus, an invention that would enable a much larger portion of energy buyers to actually benefit from deregulated markets would have tremendous value to the individual energy buyers by driving down their energy costs, which ultimately benefits our entire society.

In order to assist energy customers at a variety of consumption levels obtain energy at competitive prices, the inventors have conceived and reduced to practice a software and/or hardware facility that provides an automated energy brokering service that seeks to identify the most cost-efficient seller for energy buyers having a wide variety of demand levels to buy energy from (“the facility”). The facility also has automated auditing tools to ensure that the energy sellers and distribution utility are then properly billing the energy buyer, and that the broker is properly receiving its commission.

In some embodiments, the facility uses the model that it builds and maintains to determine the total cost to an energy buyer if the buyer was to switch to purchasing energy to each of at least a portion of the sellers from which the buyer is eligible to buy energy. In some embodiments, the facility uses this model as a basis for determining whether to recommend to a buyer that the buyer switch to purchasing energy from a different seller. In some embodiments, based on preauthorization from the buyer, the facility switches the buyer to a new seller automatically. In some embodiments, the facility uses the model to detect errors in bills generated for a buyer, and in some embodiments addresses them automatically.

A buyer who decides to use the automated brokering service provides his login credentials for an energy customer website operated by the distribution utility. The facility uses these credentials to retrieve from the distribution utility's website past bills for the buyer. The facility extracts from these bills information such as the following, performing OCR if necessary to obtain the textual content of the bills: the amount of energy consumed during the billing period, the identity of the seller, the amount charged by the seller, and the amount charged by each of one or more taxing authorities. The facility uses the information extracted from the retrieved bills to construct and maintain several models: from all of the bills, irrespective of seller identity, a model of the buyer's energy consumption, which may vary over time of year and/or in relation to weather patterns; from the most recent bill and any earlier bills identifying the same seller, a model of the price charged to the buyer by the seller for energy, which may vary by consumption level, over time of year, and/or in relation to weather patterns; and a model of the tax charged by each taxing authority, which may vary by consumption level, by price charged to the buyer by the seller, and over time of year. In some embodiments, the facility uses these models to predict the consumption level, price charged by seller, and tax charged by taxing authorities for the upcoming billing period; compares the actual amounts buyer bill for that billing period to the predicted amounts; and attempts to improve the model for any amount that was not predicted with sufficient accuracy. As the facility continues to collect and analyze bills for different energy customers, it continues to update its models using the service as a form of machine learning.

In some embodiments, the nature of the models generated by the facility is that the facility maintains a bill corpus table in which each entry represents an energy bill received by the facility, containing (1) information about the customer and its location, (2) information about the seller, (3) consumption amount during the billing period, and (4) amount charged for each of a number of “determinants,” or different aspects separately charged for, including such aspects as aspects of price charged by the seller, taxes imposed by taxing authorities, and a distribution charge charged by the distribution utility. For a particular buyer, the facility selects entries of the bill corpus table that are most similar to the buyer's situation, in terms of such details as geographical location, distribution utility identity, level of consumption, etc. The facility then aggregates the rates imposed for each determinant across the selected entries, such as in a manner that weights each selected row based on its level of similarity to the buyer's situation. In some embodiments, the facility compares the results of applying its model to bills received by buyers using the service to (1) identify and address any errors in these bills on the buyers' behalf, and (2) keep the model abreast of legitimate changes in pricing by suppliers or utilities, tax levels, etc.

In order to identify the most efficient seller for a particular buyer, the facility uses its consumption level model for the buyer to predict a level of consumption for each of a number of upcoming billing periods. The facility uses the pricing structures retrieved from each seller that the buyer is eligible to select to determine how much the buyer would pay to purchase the predicted amount of energy from the seller in the upcoming billing periods. The facility uses its tax models to determine how much tax the buyer would pay to purchase the predicted amount of energy from the seller in the upcoming billing periods. The facility can then recommend to the buyer, or, in some embodiments, even automatically select on the buyer's behalf, the seller for which the total of estimated payments to seller and taxing authority across the upcoming billing periods would be lowest. In some embodiments, the facility also considers switching costs as part of selecting the optional seller for the buyer.

In some embodiments, the facility further recommends or selects a contract term for the buyer with its new seller, considering such factors as anticipated market volatility patterns, long-term price trends, differential switching costs, etc.

In some embodiments, the operator of the facility registers with each seller as a broker, to enable the facility to regularly automatically retrieve the seller's pricing structure, and use this downloaded pricing structure as a basis for identifying the most efficient seller for a buyer.

In some embodiments, the facility assembles groups of buyers that are likely to appeal to one or more sellers based upon their collective demand profile. A demand profile is an indication of the rate at which the buyer consumes energy during days of certain kinds, or portions of such days. For example, a buyer's demand profile may indicate the rate at which the buyer consumes power on days during each season: winter, spring, summer, and fall. A profile may further indicate the rate at which a buyer consumes power on different days of the week, such as on each of the seven days of the week, or such as on weekdays versus weekend days. A profile may indicate the rate at which the buyer consumes power for shorter periods within a day, such as 12 hour periods, 8 hour periods, 6 hour periods, 2 hour periods, 1 hour periods, 30 minute periods, 15 minute periods, etc.

A seller may wish to sell power to a group of buyers having a certain collective consumption profile. For example, a first seller may wish to add a group of buyers that have a collective consumption profile that is flat—that is, relatively invariant across the different kinds of periods measured by the profile. Such a group can be attractive, for example, because the flat blocks of energy needed to satisfy the collective demand of such a group are commonly traded, and can be straightforwardly purchased by such a seller from power generators or intermediate traders. A second buyer may wish to sell to buyers having a collective profile that is non-uniform, for example because the particular non-uniform demand profile matches a non-uniform generation profile for a particular generation facility. For example, a solar generation facility may have a generation profile that peaks in the middle of the day and is higher in the summer than the winter, while wind, hydroelectric, and wave motion generation facilities may have different non-uniform generation profiles. A seller may also wish to sell to a group of buyers having a particular non-uniform consumption profile in order to complement an existing buyer or buyers to which the seller is already selling that collectively have the inverse non-uniform consumption profile. For example, a seller who is selling a buyer whose consumption is concentrated on weekdays may wish to sell to a group of buyers whose collective consumption profile is heavily weighted toward weekend days.

The facility first determines, for a particular seller, the collective consumption profile to which the seller is interested in selling. In various embodiments, the facility does this by soliciting the seller via various channels, or inferring the collective consumption profile that the seller would favor, such as by inferring that most sellers may favor a flat consumption profile. The facility then analyzes the consumption profiles of buyers, and seeks to assemble a group of buyers whose collective consumption profile is a good match with the consumption profiles sought by the seller. The facility then seeks a quote from the seller on that group based upon its collective consumption profile, and compares the quote to the price currently being paid by the buyers in the group. If the quoted price is an improvement for all of the buyers in the group, then the facility switches the buyers in the group to the seller; otherwise, the facility seeks to reconstitute the group without the buyers for which the quoted price did not constitute an improvement.

In some embodiments, the facility includes an automated mechanism for charging or otherwise being paid by buyers and/or sellers for their participation in the service provided using the facility.

In some embodiments, the operator of the facility arranges to be paid by buyers. In various such embodiments, the facility periodically determines an amount to charge each seller on a variety of bases, such as a flat periodic charge; a charge based upon the volume of energy consumed by the buyer; a percentage of the amount of money spent by the buyer on energy at an earlier time; a percentage of the amount of money spent by the buyer at a current time; a percentage of the amount of money saved by the buyer through operation of the facility; etc.

In some embodiments, the operator of the facility arranges to be paid by sellers. In various such embodiments, the facility uses a variety of approaches to calculate the amount charged to each seller, such as a fixed periodic amount to be included among the candidates to which buyers can be switched; amounts relating to buyers who are actually switched to the seller, such as an amount based upon the volume of energy consumed by switched buyers, or the amount of money paid for energy by switched buyers, etc.

In some embodiments, the facility uses its access to and digestion of energy bills generated for buyers participating in the service provided by the facility to verify that payments by buyers and/or sellers to the operator of the facility are correct. For example, where the amount to be paid is determined based upon the volume of energy consumed, the facility verifies that payments made accurately reflect the volume of energy consumed by certain buyers.

By performing in some or all of the ways described above, the facility enables energy buyers of virtually any size to purchase energy at competitive prices, generates revenue for an operator of the facility, and/or consolidates demand for energy, leading to a potentially more rational market.

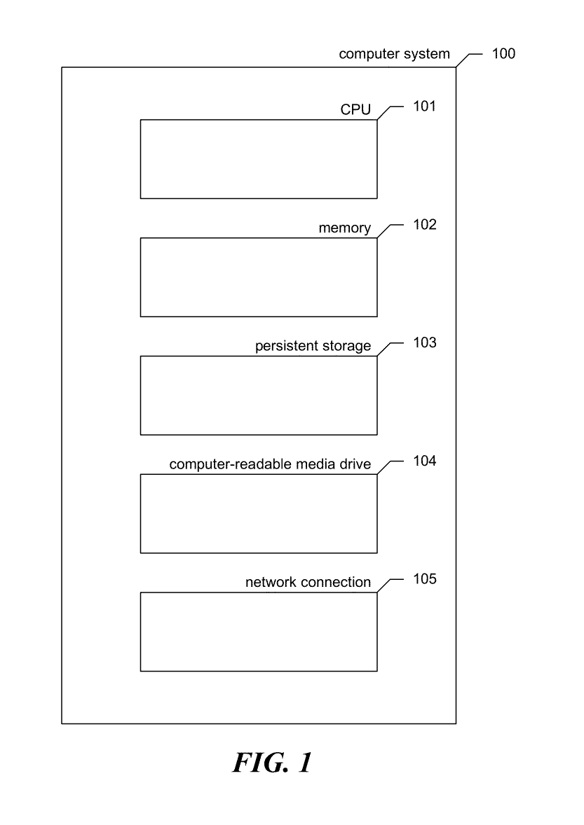

FIG. 1 is a block diagram showing some of the components typically incorporated in at least some of the computer systems and other devices on which the facility operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

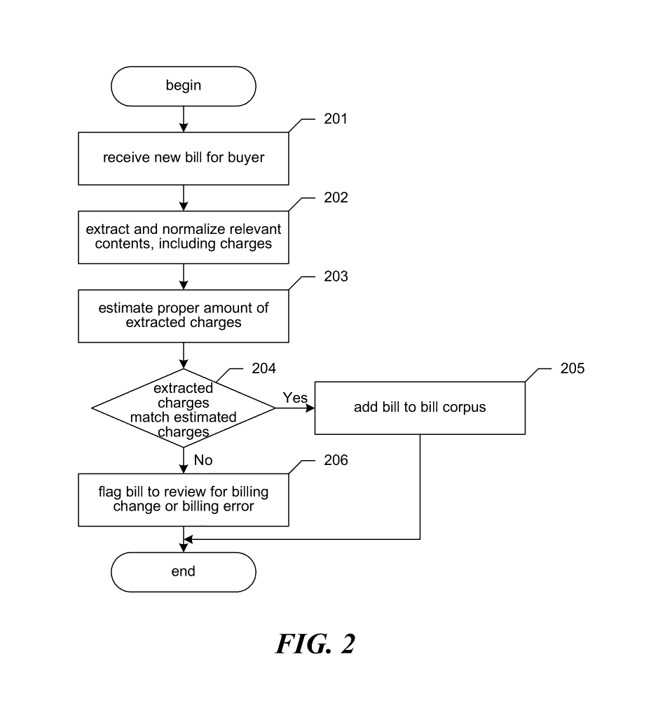

FIG. 2 is flow diagram showing steps typically performed by the facility in some embodiments in order to process a new bill received or retrieved for a particular energy buyer. In step 201, the facility receives a new bill for a particular buyer. In some embodiments, in step 201, the facility retrieves the bill from a distribution utility website using login credentials provided to the facility by the buyer. In some embodiments, in step 201, the facility receives a bill transmitted from the distribution utility to the facility in response to instructions from the buyer or from the facility.

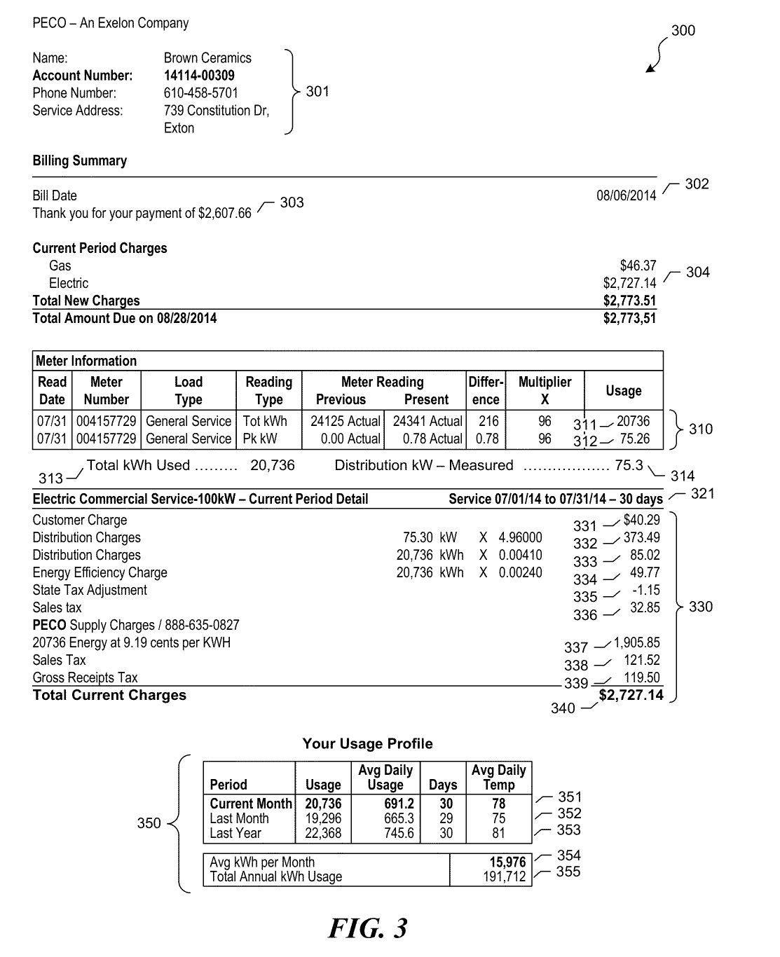

FIG. 3 is a document diagram showing a sample bill to be verified. The bill 300 includes identifying information for the buyer, including name, account number, phone number, and service address. The bill further includes a billing summary that includes a bill date 302, a last payment amount 303, and an amount due 303 for electric service during the bill period. The bill further includes electrical meter information 310, including a meter reading for total kilowatt hours 311, and a reading for peak kilowatts 312. For total kilowatt hours 311, a meter reading on Jul. 31, 2014, of 24341 is compared to a meter reading at the beginning of the billing period of 24125, to arrive at a difference of 216 that, when multiplied by the multiplier 96, arrives at the usage of 20736 total kilowatt hours used 313. Similarly, a meter reading for peak kilowatts 312 on Jul. 31, 2014, yielded 0.78, that, when multiplied by the multiplier 96, results in a usage of 75.26 distribution kilowatts 314. The bill further identifies a service period 321 of Jul. 1, 2014, to Jul. 31, 2014. The bill further includes charges 330 including the following: a customer charge 331 of $40.29; a distribution charge 332 of $373.49 arrived at by multiplying 75.30 kilowatts peak usage by a weight of $4.96 per kilowatt; a distribution charge 333 of $85.02 arrived at by multiplying 20736 total kilowatt hours by a rate of $0.00410; an energy efficiency charge 334 of $49.77 obtained by multiplying 20736 total kilowatt hours by a rate $0.00240; a state tax adjustment 335 of $1.15; a sales tax charge 336 of $32,85; and the following charges on behalf of the energy seller: an energy charge 337 of $1,905.85 arrived at by multiplying 20736 total kilowatt hours by a rate of $0.0919 per kilowatt hour; a sales tax amount 338 of $121.52; and a gross receipts tax amount 339 of $119.50. The bill further includes a total current electrical charges amount 340 of $2,727.14. The bill further includes usage profile information 350, including energy usage, average daily usage, period length, and average daily temperatures for the current month 351, the last month 352, and the last year 353; also average kilowatt hours per month 354 and total annual kilowatt hour usage 355.

Returning to FIG. 2, in step 202, the facility extracts and normalizes the relevant contents of the bill received in step 202, including each of the charges. Table 1A below contains the basic information extracted from the bill shown in FIG. 3. In various embodiments, the facility does the extraction from a PDF file, image, or a web page using various combinations of automated and manual processes. The Processed:False indication reflects that this bill has not yet been verified, so it is not yet available to be used as an observation in the bill corpus.

TABLE 1A
Basic Information from bill to be verified

| Account | | | Service | | | | |
|---|---|---|---|---|---|---|---|
| number | Period start | Period end | type | Utility | Supplier | Rate class | Processed |
| 14114-00309 | Jul. 1, 2014 | Jul. 31, 2014 | Electric | PECO | PECO | Electric Commercial | False |
| | | | | | | Service 0-100 kW | |

Table 1B below includes meter readings that the facility extracts from the bill shown in FIG. 3.

TABLE 1B
Meter Readings from bill to be verified

| | | |
|---|---|---|
| Reading type | Value | Meter Number |

| | | | |
|---|---|---|---|
| Total Energy | 20736 | kWh | 004157729 |
| Demand | 75.3 | kW | 004157729 |

Table 1C below includes charges extracted by the facility from the bill shown in FIG. 3. Because bill formats vary from utility to utility, and even among customers of the same utility, in some embodiments the facility maps variant names for charges each to a standardized name. Further, the facility classifies each charge as either a supply charge that is determined by the supplier or a distribution charge that is associated with the utility and rate class. Taxes are associated with utility and rate class because each rate class is specific to a jurisdiction.

TABLE 1C
Charges from bill to be verified

| Name | Type | Quantity | | Rate | Total |
|---|---|---|---|---|---|
| Customer Charge | Distribution | $40.29 | | 1 | $40.29 |
| Distribution | Distribution | 75.3 | kW | 4.96 | $373.49 |
| Charges | | | | | |
| [Demand] | | | | | |
| Distribution | Distribution | 20,736 | kWh | 0.0041 | $85.02 |
| Charges | | | | | |
| [Energy] | | | | | |
| Energy | Distribution | 20,736 | kWh | 0.0024 | $49.77 |
| Efficiency | | | | | |
| Charge | | | | | |
| State Tax | Distribution | $498.8 | | −0.0023 | −$1.15 |
| Adjustment | | | | | |
| Sales Tax | Distribution | $547.50 | | 0.08 | $32.85 |
| [Distribution] | | | | | |
| Supply Charge | Supply | 20,736 | kWh | .0919 | $1905.85 |

| | | | | |
|---|---|---|---|---|
| Sales Tax | Distribution | $2025.35 | 0.06 | $121.52 |
| [Supply] | | | | |

The bill shown in FIG. 3 shows sales tax for both supply and distribution together, because PECO is both the supplier (seller) and the distribution utility; bills where the supplier is different from the distribution utility shows separate charges for supply and distribution sales tax. Sales tax on supply charges is part of the overall supply cost, but when estimating charges, in some embodiments, the facility classifies sales tax on supply charges—such as a gross receipts tax—as a distribution charge because it is determined by the utility and rate class.

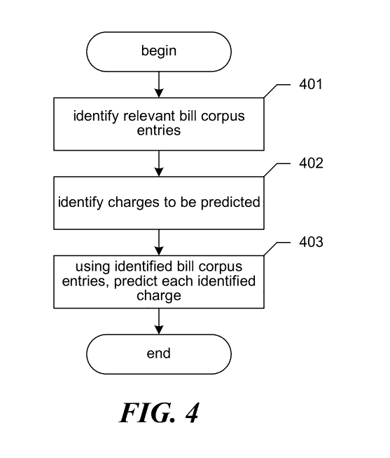

In step 203, as a basis for assessing the validity of this bill, the facility uses its model to estimate the proper amount of each of the extracted charges, such as the charges shown in Table 1C above. Additional details of step 203 are discussed in connection with FIG. 4 below. In step 204, if the charges extracted in step 202 match the charges estimated in step 203, then the facility continues in step 205, else the facility continues in step 206. In some embodiments, to determine if an estimate for a particular charge is correct, the facility uses a heuristic that is based on the estimate, the actual charges that appear on the bill, and data from the estimation processes such as the scores s(A,c) discussed below. In various embodiments, the facility uses varying degrees of error tolerance and human intervention depending upon the situation. The facility determines that the estimate for a group of charges is correct, if and only if the correct set of charges was included and the estimates for all the included charges are correct. In step 205, the facility adds the received bill to its bill corpus for use in estimating other bills. After step 205, these steps conclude. In step 206, because not all of the charges matched, the facility flags the bill to be reviewed for either a valid change in billing practices, or a billing error that deviates from proper billing practices. In some cases, estimates fail to be matched because of rates that change between billing periods. Other possible causes include seasonal charges and tariff changes that add or remove charges or change the definitions of charges over time. In some embodiments, where a billing error is found, the facility automatically notifies the utility that generated the bill of the error. After step 206, these steps conclude.

Those skilled in the art will appreciate that the steps shown in FIG. 2 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

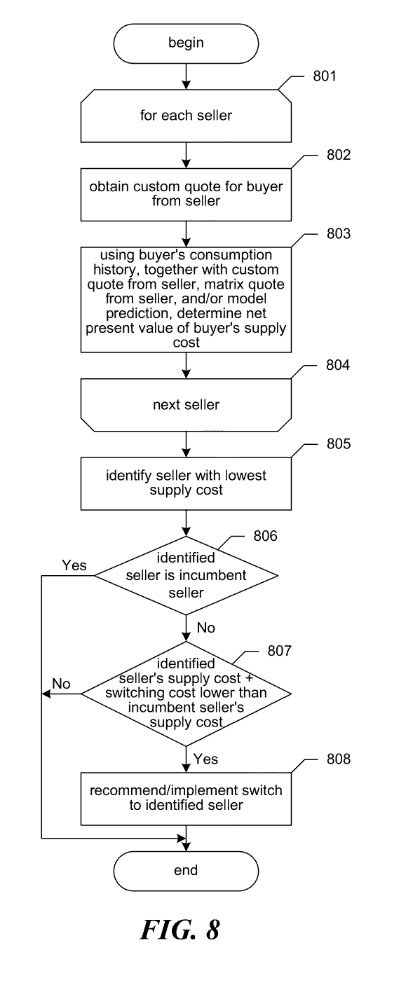

FIG. 4 is a flow diagram showing steps typically performed by the facility in some embodiments in order to estimate the proper amount of certain charges for a particular power buyer for a particular billing period. The billing period may be in the past, or in the future. The facility may perform these steps in step 203 as part of verifying the correctness of a buyer's bill. The facility may also perform these steps in connection with FIG. 8 discussed below as part of projecting the cost of this buyer purchasing power from a particular seller for a future period as part of determining which seller would be most cost-efficient for the buyer for that period. In step 401, the facility identifies entries of the bill corpus that are relevant to this estimation. In some embodiments, the facility treats processed (i.e. verified) bills with the same utility and rate class as the bill to be estimated to the relevant observations for estimating distribution charges. Further, in some embodiments, the facility treats processed bills with the same supplier (or supply contract) as the bill to be estimated as relevant observations for estimating supply charges. Table 2 below shows a small set of examples of bills in the bill corpus table whose relevance to this estimation the facility considers in step 401.

TABLE 2
Bill Corpus Table

| | | | | | Pro- |
|---|---|---|---|---|---|
| Period start | Period end | Utility | Supplier | Rate class | cessed |
| 2014 Jun. 17 | 2014 Jul.16 | PECO | PECO | Electric | True |
| | | | | Commercial | |
| | | | | Service | |
| | | | | 0-100 kW | |
| 2014 Jun. 20 | 2014 Jul. 20 | PECO | PECO | Electric | False |
| | | | | Commercial | |
| | | | | Service | |
| | | | | 0-100 kW | |
| 2014 Jun. 25 | 2014 Jul. 24 | BGE | BGE | General | True |
| | | | | Service | |
| | | | | Schedule C | |
| 2014 Jul. 29 | 2014 Jul. 30 | PECO | Direct | Electric | True |
| | | | Energy | Commercial | |
| | | | | Service | |
| | | | | 0-100 kW | |
| 2014 Jul. 2 | 2014 Aug. 1 | PECO | PECO | Electric | True |
| | | | | Commercial | |
| | | | | Service | |
| | | | | 0-100 kW | |
| 2014 Apr. 2 | 2014 Apr. 30 | PECO | PECO | Electric | True |
| | | | | Commercial | |
| | | | | Service | |
| | | | | 100-500 kW | |
| . . . | . . . | . . . | . . . | . . . | . . . |

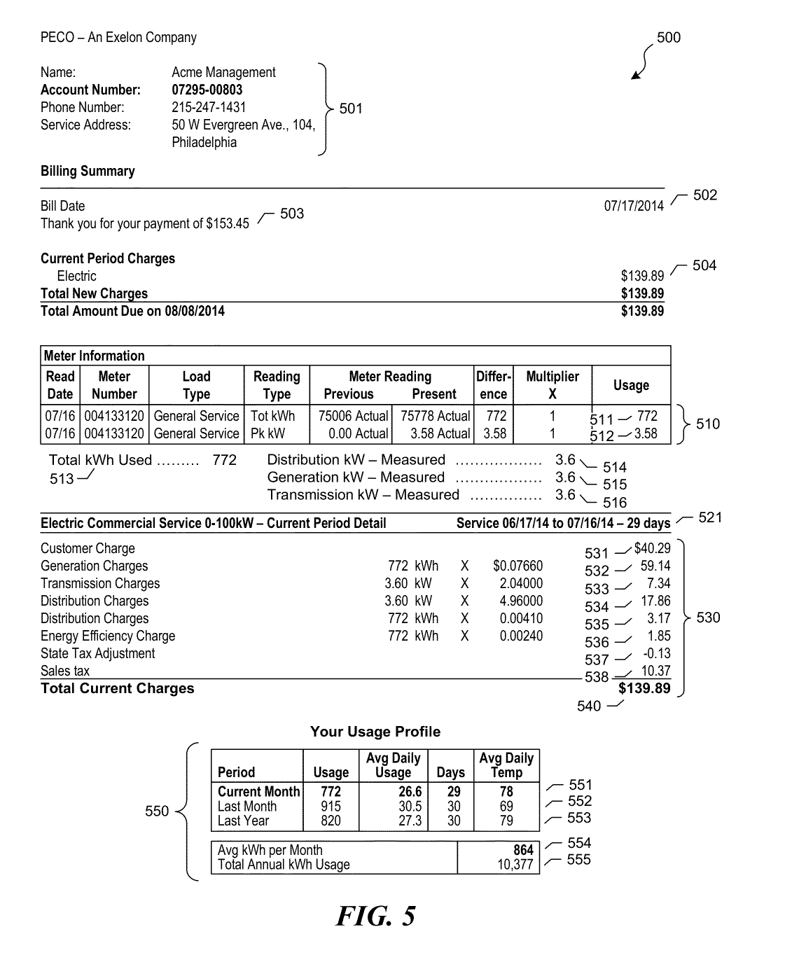

As an example of one of the bills included in the sample bill corpus table shown in Table 2, FIG. 5 is a document diagram showing a sample bill corresponding to the first entry of the sample bill corpus table shown in Table 2. It can be seen from comparing FIG. 5 to FIG. 3 that the bill 500 shown in FIG. 5 contains information generally corresponding to the bill 300 shown in FIG. 3. The information extracted from bill 500 in some embodiments by the facility is shown in Tables 3A, 3B, and 3C below.

TABLE 3A
Basic Information from bill in corpus

| ccount | | | Service | | | | |
|---|---|---|---|---|---|---|---|
| number | Period start | Period end | type | Utility | Supplier | Rate class | Processed |
| 07295-00802 | Jun. 17, 2014 | Jul. 16, 2014 | Electric | PECO | PECO | Electric Commercial | False |
| | | | | | | Service 0-100 kW | |

TABLE 3B
Meter Readings from bill in corpus

| | | |
|---|---|---|
| Reading type | Value | Meter Number |

| | | | |
|---|---|---|---|
| Total Energy | 772 | kWh | 004133120 |
| Demand | 3.60 | kW | 004133120 |

TABLE 3C
Charges from bill in corpus

| Name | Type | Quantity | | Rate | Total |
|---|---|---|---|---|---|
| Customer Charge | Distribution | $40.29 | | 1 | $40.29 |
| Generation Charges | Supply | 772 | kWh | 0.07660 | $59.14 |
| Transmission Charges | Supply | 3.60 | kW | 2.04000 | $7.34 |
| Distribution Charges | Distribution | 3.60 | kW | 4.96000 | $17.86 |
| [Demand] | | | | | |
| Distribution Charges | Distribution | 772 | kWh | 0.00410 | $3.17 |
| [Energy] | | | | | |
| Energy Efficiency | Distribution | 772 | kWh | 0.00240 | $1.85 |
| Charge | | | | | |

| | | | | |
|---|---|---|---|---|
| State Tax Adjustment | Distribution | $61.32 | −0.00212 | −$0.13 |
| Sales Tax | Distribution | $129.65 | 0.08 | $10.37 |

Among the six entries of the bill corpus table shown in Table 2 above, the facility identifies the first, fourth, and fifth entries as relevant to estimating distribution charges for the bill shown in FIG. 3. The facility eliminates the second entry because it is not marked as processed; eliminates the third entry because it has a different utility and rate class than the bill shown in FIG. 3; and eliminates the sixth because it has a different rate class than the bill shown in FIG. 3. For estimating supply charges, the facility identifies the first, second, fifth, and sixth entries, which all have the same supplier as the bill shown in FIG. 3.

In step 402, the facility identifies the charges to predicted. In addition to charges predicted by this method, which are called “shared” charges, there may also be “individual” charges that apply only to a particular customer. These account for special situations such as custom supply contracts that apply only to one customer, fees for late payment, or adjustments. The presence or absence of “individual” charges in a bill has no effect on bills for other customers. Where the steps of FIG. 4 are being performed as part of step 703, in some embodiments, the facility simply identifies the charges extracted from the bill being verified. In some embodiments, the facility performs the following process to identify charges to be predicted, in some cases even where a bill is being verified and the list of charges extracted from it is known.

Let R be a set of relevant bills for determining the supply or distribution charges of a newly-received bill A as determined by the facility in step 401. For every other bill B in R, the facility uses a function f(A,B) to measure the relevance of the bill B in determining the charges of the bill A. In various embodiments, this function f depends on a variety of data associated with the bills A and B.

In some embodiments, f depends only on the start dates and end dates of the two bills, and is defined as f(A,B)=w(|A_start−B_start|+|A_end−B_end|), where w is a strictly decreasing weight function that assigns a high weight to bills whose periods are close to that of A and a low weight to bills whose periods are far away. In some embodiments, w is always positive so that no bill will be too far away to count at all.

To determine whether the new bill A includes some charge c from the set of all known charges found in bills in R, the facility calculates a score s(A, C) using f as follows:

$$s ( A , c ) = {\sum }_{B ∈ R} [ i ( B , c ) f ( A , B ) ] {\sum }_{B ∈ R} f ( A , B ) \qquad ( 1 )$$

where i(B, c)=1 if the bill B includes the charge c, and 0 if it does not. Dividing by the total weight shown in the denominator normalizes the score to [0,1], making it independent of the number of bills collected in R.

Finally, let t be some threshold in [0, 1], such as 0.5. The facility includes charge c in the estimated set of charges for A if s(A, c)>t.

In some embodiments, the facility stores the score s(A, c) for each included and excluded candidate charge to serve as a measure of confidence in the estimate: if s(A, C) is far from t, the inclusion of charge c in the estimate is more likely to be correct, but a value closer to t suggests that the estimate might be wrong.

In some embodiments, the facility determines the effectiveness of a particular choice of values for parameters like t and f by measuring the accuracy of the above procedure in predicting the already-known charges of each bill that has already been processed, using only other bills that were present at the time that bill was originally estimated. The facility automatically chooses optimal values of these parameters, and automatically updates them by repeatedly measuring performance with different parameter values as new bills are received. In addition, in some embodiments, the facility chooses different sets of parameters for different groups of bills (e.g. by rate class) or different types of charges by measuring performance for each group individually.

In step 403, the facility uses the bill corpus entries identified in step 401 to predict each of the charges identified in step 402. In particular, the facility generates a model that, for each identified charge, enables the facility to recalculate the charge in a scenario of different energy usage. This model includes a function of meter reading values, and potentially other inputs, as well as a rate that is multiplied by the value of the function to get the total charge amount. The rate is kept separate from the function because it typically varies more frequently than the function. Once the facility determines that charge c belongs to the estimate for bill A, the facility determines each part of the model for the charge, including the function and the rate, using the other occurrences of the charge c among the bills in R.

In some embodiments, the facility determines these by identifying the bill B that has the highest relevance f(A, B) above. In some embodiments, the facility stores the most highly relevant bill as part of step 402 during the earlier computation of the score s(A, c), so the function and rate for c in the estimate for A can be set to match the occurrence of c in B.

In some embodiments, rather than using a single most relevant bill as a basis for determining the function and rate for each charge to be estimated, the facility performs the prediction as follows:

For each charge, the facility defines a “model template” for that charge to be a function that expresses the charge amount in terms of meter values and unknown constants (including rates). For example, in some embodiments, for a charge c, the facility defines the template “c(m1, m2)=a*m1+b*m2”, where m1 and m2 are meter reading values, and a and b are rates that change periodically and may not be known. The facility determines the actual model for a charge in a particular set of bills by substituting specific values for the unknown constants. For example, in some cases, the model for e is “c(m1, m2)=1.2*m1+3.4*2”.

Also, for each charge, there is a known rule for determining time-based groups of bills such that the model of the charge is the same for every bill in the group (a “bill grouping rule”). For example, in some cases, the rates a and b in the model for charge c are the same for every bill whose period ends in the same calendar month. (Different charges for the same rate class or supplier may have different grouping rules, but often they all have the same one.)

In some embodiments, both the model template for each charge and the bill grouping rule are inputted by a person, based on reviewing the document that defines them, such as a tariff or terms of a supply contract. In some embodiments, the facility automatically determines the model template in bill grouping rule by applying analysis techniques such as regression analysis to a large number of processed bills in the bill corpus.

To determine the model for an occurrence of a particular charge on a newly-received bill, the facility collects a set of relevant other bills using the same criteria discussed above in connection with step 402, except restricted to a group determined by the grouping rule. Regression is used to estimate the unknown constants (e.g., a and b), using known meter read (e.g. m1 and m2) and total amounts of the charge for each bill in the group. The facility substitutes these estimates into the model template.

In some embodiments, if a large majority of occurrences of the charge in the corpus closely fit the regression, the facility treats any occurrences that do not fit as potential errors on the part of the utility, thus identifying billing errors for resolution. Any significant error in the regression indicates that the model template or grouping rule have become wrong and should be updated.

In some embodiments, the facility predicts the model template by trying several common function types and choosing the one that fits best.

In some embodiments, given the model template, the facility predicts the grouping rule.

In some embodiments, the facility “monitors” tariff documents via information sources such as the web to obtain advance notice when model changes are going to happen, enabling the facility to update them before they become wrong.

In some embodiments, the facility estimates supply charges for non-SOS supply contracts (i.e., where the supplier is not the same as the utility) using not just other bills, but also previously received quotes from the suppliers, which may be easier to obtain, and are likely to include a rate for every type of customer.

Table 4 shows the facility's prediction of each identified charge in the bill shown in FIG. 3.

TABLE 4
Estimation of Distribution Charges

| Name | Type | Model function | Quantity | | Rate | Total |
|---|---|---|---|---|---|---|
| Customer Charge | Distribution | 40.29 | $40.29 | | 1 | $40.29 |
| Distribution Charges [Demand] | Distribution | demand | 75.3 | kW | 2.04 | $373.49 |
| Distribution Charges [Energy] | Distribution | total energy | 20,736 | kWh | .00410 | $85.02 |
| Energy Efficiency Charge | Distribution | total energy | 20,736 | kWh | .00240 | $49.77 |

| | | | | | |
|---|---|---|---|---|---|
| State Tax Adjustment | Distribution | Customer Charge + | $498.8 | −.00212 | −$1.06 |
| | | Distribution Charges | | | |
| | | [Demand] + | | | |
| | | Distribution Charges | | | |
| | | [Energy] | | | |
| Sales Tax [Distribution] | Distribution | Customer Charge + | $548.48 | 0.06 | $32.85 |
| | | Distribution Charges | | | |
| | | [Demand] + | | | |
| | | Distribution Charges | | | |
| | | [Energy] + Energy | | | |
| | | Efficiency Charge | | | |

By comparing the quantities, rates, and totals between Tables 4 and 1 c, it can be seen that the state tax adjustment rate that was predicted, −0.00212 differs from the state tax adjustment rate that was extracted from the bill shown in FIG. 3, −0.0023, causing the state tax adjustment total to also diverge. Additionally, the quantity and total for sales tax [distribution] also diverge because of a dependency of that quantity on the divergent state tax adjustment rate. The facility therefore flags this aspect of the bill in FIG. 3 to review. Such review may reveal that the correct rate recently changed, that the bill in FIG. 3 should be treated as validated, and the bill in FIG. 5 should be removed from the bill corpus as no longer accurate; or, the facility may determine that the rate shown on the bill in FIG. 3 is erroneous, and pursue correction of the error. After steps 403, the steps shown in FIG. 4 conclude.

Many suppliers offer both matrix quotes and custom quotes. Matrix quotes are typically generated once a day and apply to all customers with a particular utility, rate class, and minimum/maximum annual energy consumption. Custom quotes sometimes have lower prices than matrix quotes, but are costly for suppliers to produce, so suppliers often only provide custom quotes for customers whose annual energy consumption exceeds some threshold specific to each supplier (such as 500 MWH), and will only provide a limited number of custom quotes overall. There is generally no charge for requesting quotes.

Some suppliers don't have matrices and only provide custom quotes.

All quotes have an expiration date, which is usually 5:00 pm EST on the day they are provided. Some custom quotes are valid for two days.

A repeated request for a custom quote for a given customer from the same supplier is called a “refresh.” A refresh tends to be less costly to the supplier than an initial quote, so there is less need to limit the number of refreshes than the number of initial quotes.

Supply contracts generally start and end on utility billing period dates, so each utility billing period generally belongs to one contract period. Contract lengths are usually a whole number of months (i.e. utility billing periods) up to 36 (usually 6, 12, 18, 24, or 36).

A single custom quote may be provided for a group of buildings (known as “aggregation”). This usually results in a lower price than custom or matrix quotes for each building individually, but requires all the buildings to start service at the same time. In some embodiments, the facility extends this advantage to groups of buildings with multiple owners.

In some embodiments, when determining the best contract for a customer, the facility considers a variety of contract terms other than price, which in some cases are not shown in the quotes.

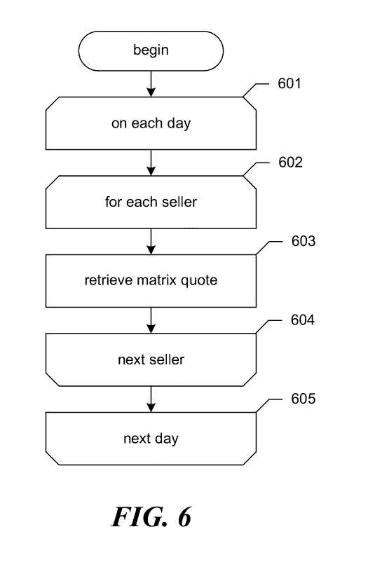

FIG. 6 is a flow diagram showing steps typically performed by the facility in order to maintain current copies of matrix quotes for each energy seller that summarize the terms on which the seller sells energy to different classes of customers. The facility repeats the loop of steps 601-605 each day, or in accordance with another suitable period. In steps 602-604, the facility loops through each seller that makes a matrix quote available. In step 603, the facility retrieves a current version of the matrix quote from the seller.

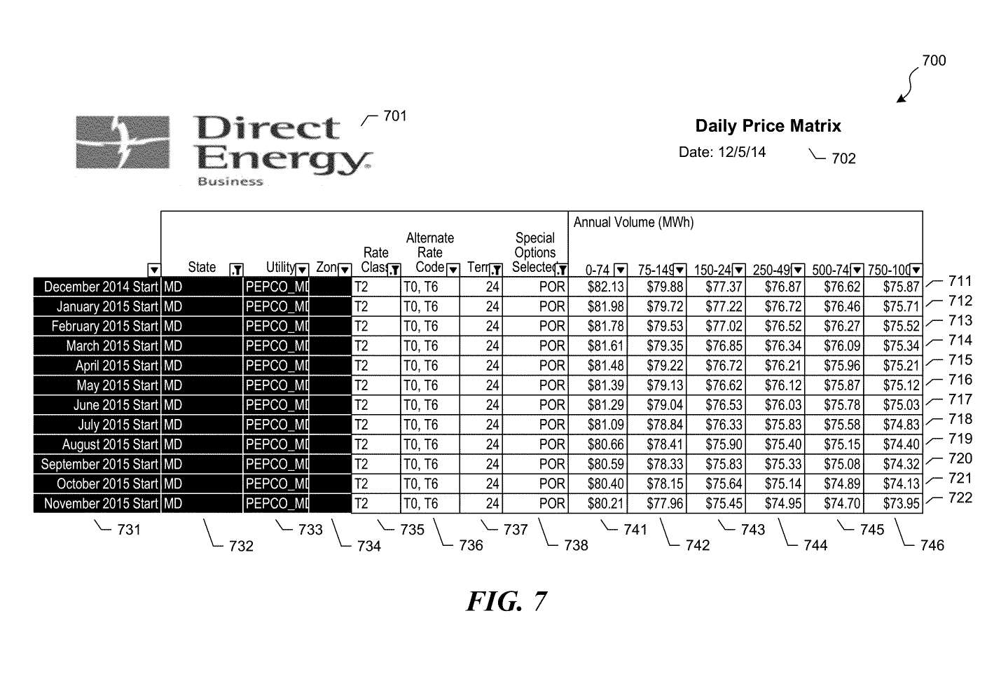

FIG. 7 is a document diagram showing a matrix quote retrieved by the facility from a particular seller. The matrix quote 700 identifies the seller 701 to which the quote pertains, and the date 702 on which the matrix quote is valid. The shown table, or “matrix,” contains a row 712-722 each corresponding to a different month in which service might begin. In each row, the matrix contains identifying information 732-738 for customers to whom the row applies, as well as prices 741-746 established for customers who use different annual energy volumes, measured in megawatt hours, and who begin as customers in the month to which the row corresponds. For example, the intersection of row 712 and column 742 indicates that for a customer in the state of Maryland served by the utility PEPCO_MI in rate class T2 with alternate rate codes T0 and T6 who begin a 24-month contract in January 2015, and consume an annual volume between 75 megawatt hours and 149 megawatt hours, the quoted price is $79.72 per megawatt hour.

FIG. 8 is a flow diagram showing steps typically performed by the facility in order to determine whether a particular buyer should switch from its current seller to a new seller. In some embodiments, the facility performs these steps periodically for each buyer using its service, such as each minute, each hour, daily, weekly, monthly, etc. In steps 801-804, the facility loops through each seller. In some embodiments, the set of sellers considered by the facility in steps 801-804 include:
The customer's current contract
The utility's standard offer service (SOS) contract if it is not the current one
All available matrix quotes that apply to the customer

Custom quotes for the customer collected from certain suppliers as described above

In step 802, the facility obtains a custom quote for the buyer from the seller, if possible. To do so, the facility submits to the seller information characterizing the buyer, including its location, utility, consumption level, etc.

To request a custom quote, in some embodiments, the facility sends the following customer information to a supplier:
Name
Service address
Utility
Rate class
Relevant meter values (such as total energy, peak/offpeak energy, or maximum demand) for between the last 1 month and the last 12 months
Utility account number

In some cases, a supplier may ignore information other than the utility account number and use the account number to collect the information they need for the quote directly from the utility. This may include higher-resolution energy consumption data from Green Button, a standard that allows the utility to provide data about the customer's energy consumption to the customer or a third party. More information about Green Button is included in the Green Button website, available at www.greanbuttondata.org, which is hereby included by reference in its entirety.

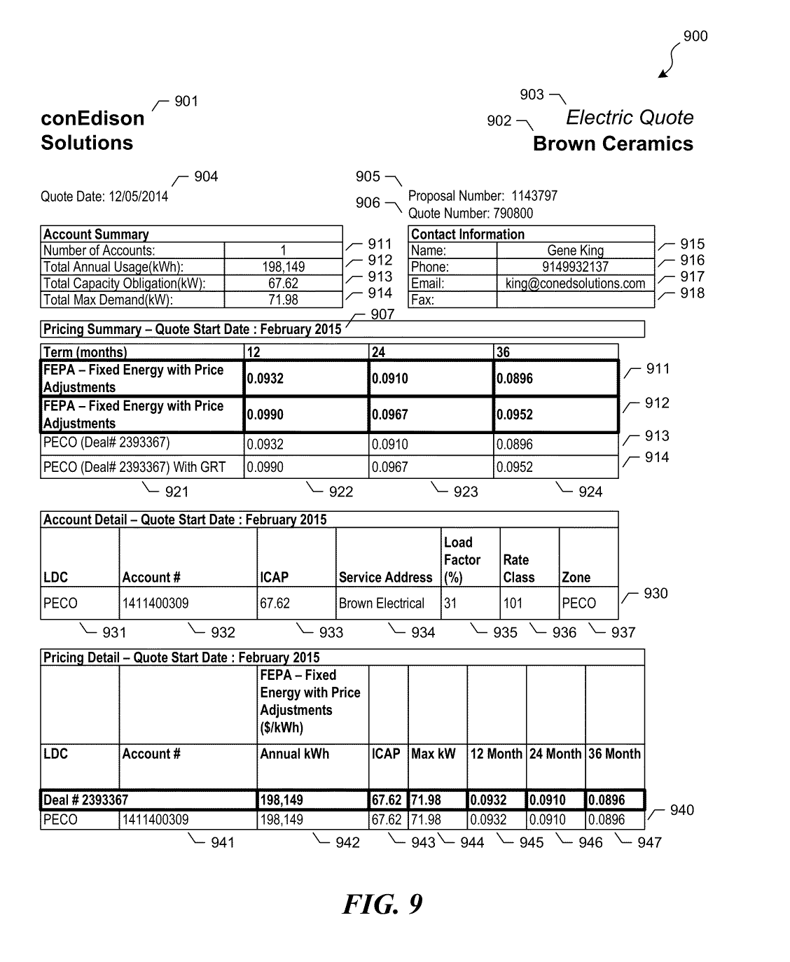

FIG. 9 is a document diagram showing a sample custom quote obtained by the facility in step 802 from a seller for a buyer. The custom quote 900 includes the identity 901 of the seller issuing the quote, the identity 902 of the customer for whom the quote is issued, an indication 903 of the type of power being quoted, here electric, a date 904 on which the quote is issued, a proposal number 905 and a quote number 906 each identifying the quote, a date 907 on which the quote begins, a number of accounts 911 being quoted, a total annual usage level 912 predicted for the buyer, a total capacity obligation 913, a total maximum demand 914, and contact information 915-918 for a representative of the seller who can discuss the quote. Each of rows 911-914 shows a price per kilowatt hour for each of three contract term lengths: 12 months, 24 months, and 36 months. Rows 911 and 912 show prices for fixed energy with price adjustments; to the prices shown in row 911, 912 adds a gross receipts tax. Rows 913 and 914 show prices for the PECO supplier and utility, with row 914 adding gross receipts tax. The custom quote also includes information 930 about the buyer, as well as additional detail 940 about the details of the quote.

Returning to FIG. 8, in step 803, the facility uses the buyer's consumption history, together with one or more of a custom quote from the seller for the buyer, a matrix quote from the seller, and/or a prediction by the facility using its model to determine a net present value over the seller's supply cost for the energy that the buyer will consume. For example, in some embodiments, the facility uses its model at least for the buyer's incumbent seller.

In some embodiments, the cost determined for each seller in step 803 includes the following factors:
Expected net present value of supply cost to the customer over the next 24 months (or maximum contract length) if this contract is chosen. When comparing two fixed-rate contracts of the same length, this means just comparing one rate. Otherwise, it may involve:
   Estimated monthly meter values such as total energy, demand, and peak/off-peak energy over the contract term. These are estimated according to the “same period last year” method using the previous year's utility bills, or from a single bill using “scalers”, which are average ratios of annual total meter values to each month's value. In some embodiments, the facility uses variations of the “same period last year” method (such as adjusting for weather) to produce a better estimate.
   An estimate of the total cost during the contract term (sum of everything in this list) for other supply contracts that will become available after the end of this contract. (Unless the customer has a contract length preference, an expected future increase in cost will cause a longer contract to be chosen for the customer, and an expected decrease will cause a shorter contract to be chosen.)
   Discount rate for comparing current costs to future costs, which may be specific to the customer.
   Early termination fee for the current contract, if any. (Some fixed-rate contracts have termination fees of $0.14/kWh for the remainder of the contract, which is insurmountable, but variable-rate contracts usually have no termination fee.)
Transaction cost to the customer of switching to a new supply contract, i.e. minimum savings threshold below which it's not worth switching. This is 0 for the current contract, and some fixed number for all other ones.
“Consolidated billing”: a slight preference may be given to suppliers that provide consolidated billing (inclusion of supply charges in the utility bill) because many customers prefer having only one bill to pay.

The facility sums the cost associated with each of these factors to produce a total cost for each candidate contract. In some embodiments, the facility considers contract with the lowest total cost the best. In some embodiments, the facility applies a weighting factor relating to clean energy. For example, in some embodiments, the buyer can specify a price premium that the buyer is willing to pay for any supplier that uses at least a threshold level of clean energy—such as a willingness to pay 10% more for any supplier that uses at least 50% clean energy.

In step 804, if additional sellers remain to be processed, then the facility continues to step 801 to process the next seller, else the facility continues to step 805. In step 805, the facility identifies the seller with the lowest supply cost. In step 806, if the identified seller is the incumbent seller from which the buyer is presently buying energy, then these steps conclude, else the facility continues in step 807. In step 807, if the identified seller's supply cost plus the cost for the buyer to switch from its incumbent seller to the identified seller is lower than the incumbent seller's supply cost, then the facility continues in step 808, else these steps conclude. In step 808, the facility recommends to the buyer, or automatically implements, a switch to the identified seller. After step 808, these steps conclude.

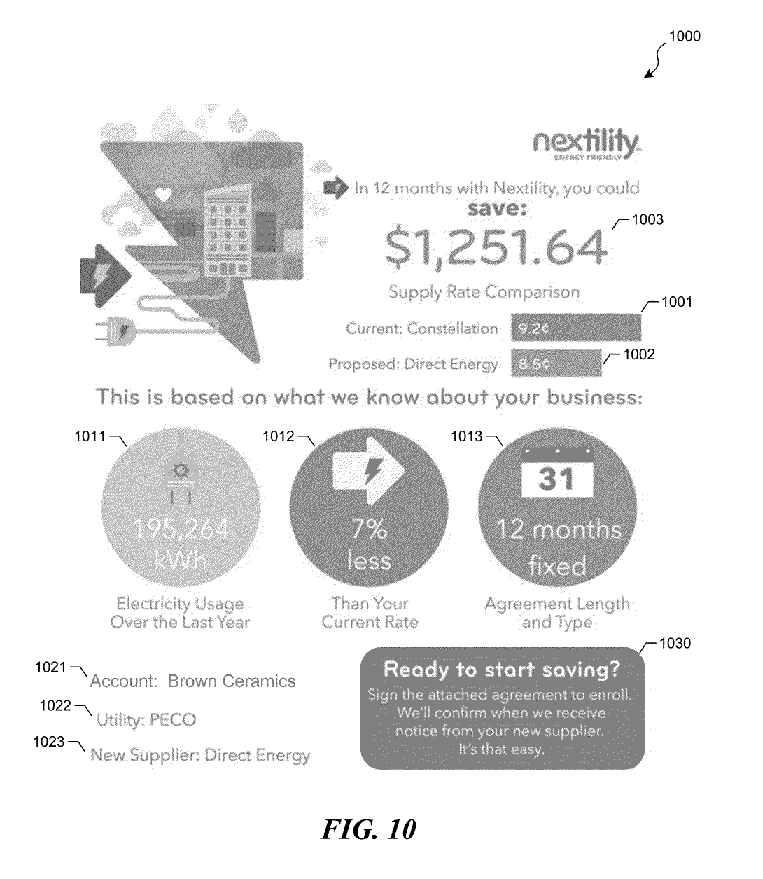

FIG. 10 is a document diagram showing a sample solicitation sent by the facility in some embodiments to recommend to a particular buyer that it switch to a different seller. The solicitation 1000 includes the buyer's per kilowatt hour price 1001 from its incumbent supplier, as well as an available per kilowatt hour price 1002 from the recommended supplier. The solicitation also includes an indication 1003 of the annual savings that the buyer would enjoy from switching. The solicitation also includes the following information about the buyer: annual consumption 1011, percent decrease in cost 1012 that would result from the switch, and agreement length and type 1013. The solicitation also includes the identity 1021 of the buyer, the identity 1022 of the buyer's utility, and the identity 1023 of the recommended supplier. The solicitation further includes information 1030 on how to effect the recommended switch. In some embodiments, such as where a buyer has previously agreed to enrollment terms, the solicitation includes a control such as a button that the user can activate in order to effect the switch. In some embodiments, as discussed above, the facility effects the switch automatically, without consulting the buyer, based upon authority earlier explicitly delegated by the buyer.

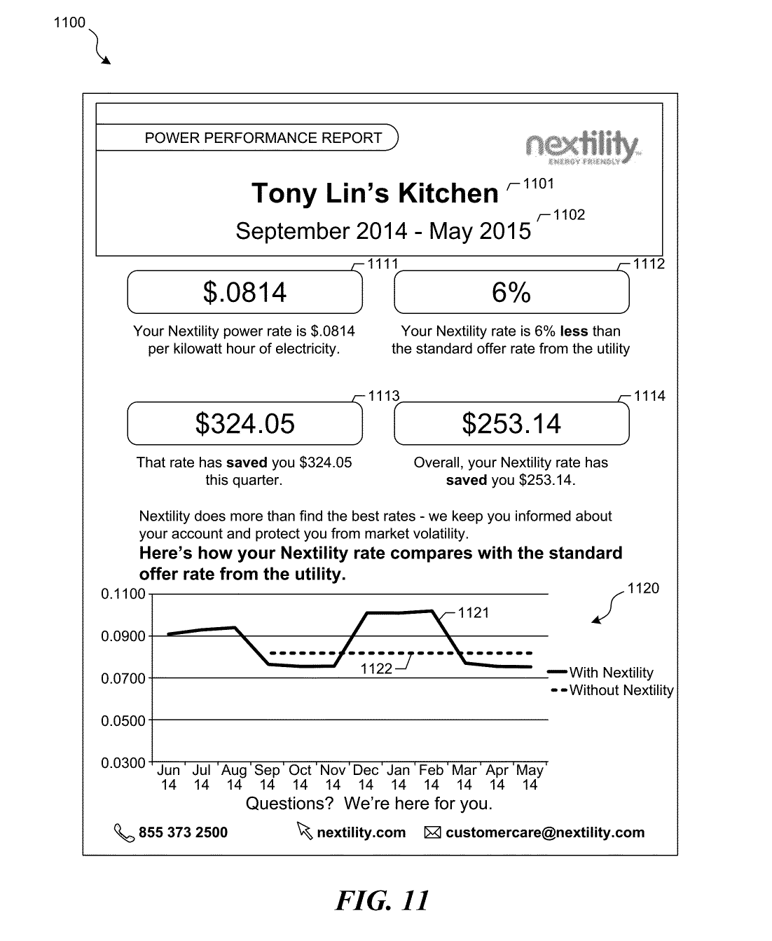

FIG. 11 is a document diagram showing a sample scorecard document sent by the facility in some embodiments to a buyer to indicate how much the buyer has saved based upon having switched to the buyer's current seller based upon the facility's operation. The report card 1100 includes the buyer's name 1101, and a time period 1102 that the report card covers. The report card further includes an overall energy price 1111 from the buyer's current supplier; a percentage savings 1112 enjoyed by the buyer overall relative to the buyer's utility's standard offer rate; an amount of money 1113 saved by the buyer during the current quarter by using its present supplier; and a total amount 1114 saved by the buyer as a result of using the service. The report card also includes a graph 1120 on which the following quantities are plotted versus time: the price 1121 charged by the buyer's current supplier recommended by the service; and the standard offer rate price 1122 offered by the buyer's utility

In some embodiments (not shown), for buyer who decline to use the service provided by the facility, the facility periodically prepares a communication like report card 1100 that shows a buyer how much the buyer would have saved had the buyer used the service provided by the facility, and/or switched to a seller recommended by the facility.

In some embodiments, the facility restricts non-SOS candidate contracts to ones that:
Start on the customer's next utility billing date,
Have a fixed rate (price does not change over time). Most suppliers offer variable-rate contracts and hybrid fixed/variable contracts but these are not considered,
Have a flat rate (price independent of quantity),
Meet the customer's risk requirements, which in some embodiments include:
   Contract length, if the customer has a preference. If there is no preference, contracts of all lengths are considered.
   Swing range, i.e. high and low limits on total energy consumption beyond which the customer must pay a higher or unpredictable price, expressed as percent variation from the monthly total energy consumption estimate. If the customer does not specify a minimum swing range, we assume 20%. (The swing range applies only to total energy consumption, not time-of-use energy or demand.)
Do not have a “material change clause” (fee for physical changes to the building that affect energy consumption), unless the swing range is big enough.
Do not have pass-through costs (costs such as demand that may be priced according to a variable rate even though total energy consumption has a fixed rate), according to the customer's preference.
Do not have an “extreme circumstance” clause, which requires the customer to pay extra in case of an extreme change in wholesale prices for the supplier (such as the 2013 “polar vortex”).
Have at least some percentage of renewable energy, according to the customer's preference. If the customer has no preference for renewable energy, both renewable and conventional contracts are considered.

In some embodiments, the facility obtains consideration from one or more sellers—such as discounted rates from the seller for buyers using the service—by providing to these sellers information about how their prices compare to competitors' prices.

In some embodiments, the facility obtains lower prices for users of the service by inviting sellers to beat a current best known price for a particular buyer or group of buyers.

Some utilities offer their customers a choice of rate class. In some embodiments, for those utilities, the facility chooses the optimum rate class for each seller as well as the best supply contract. Rather than only considering contracts for the buyer's current rate class, in such embodiments the facility considers all supply contracts for all rate classes for which the buyer is eligible, and chooses the rate class and supply contract that minimizes overall cost, that is, supply cost plus distribution cost. In some cases, this provides opportunities for beneficial switches for a buyer that would not otherwise be available.

In some embodiments, the facility includes swing range as part of the estimated cost for each contract (expected amount by which a customer's energy consumption will go above/below the limit*price difference), rather than using a minimum swing range to filter out some contracts and treating all others as equal. This could give customers more of a choice along the spectrum of cost vs. risk.

In some embodiments, rather than merely aggregating groups of buildings with the same owner to get a better custom quote, the facility aggregates buildings with multiple owners to extend the discount for aggregation to customers that have fewer buildings (or only one building).

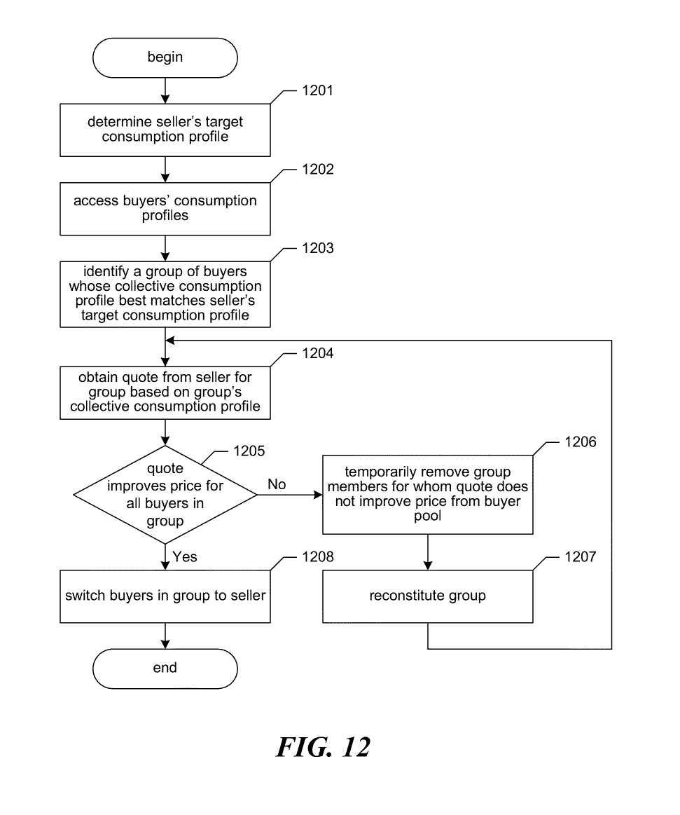

FIG. 12 is a flow diagram showing steps typically performed by the facility in some embodiments to assemble a custom group a buyers matching a seller's target consumption profile. In step 1201, the facility determines the seller's target consumption profile. In some embodiments, in step 1201, the facility solicits this information from the seller via a variety of channels, including email, a telephone call, calling an API exposed by the seller, etc. In some embodiments, in step 1201, the facility receives a communication from the seller at the seller's instigation containing this information, such as in an email message, a telephone call, submission of a web form published by the facility, a call to a API exposed by the facility, etc. In some embodiments, in step 1201, the facility infers a target consumption profile for the seller, such as by assuming that the seller is interested in groups having a flat target consumption profile.

In step 1202, the facility accesses consumption profiles for energy buyers. In some embodiments, these are buyers who are registered with the service provided by the facility, and, in some cases, buyers who have authorized the facility to switch them to a different seller. In some embodiments, the buyers whose consumption profiles the facility accesses in step 1202 are buyers whose supply contracts are ending soon, or who are for some other reason or reasons in a good position to switch to another seller. In some embodiments, the buyers whose consumption profile the facility accesses in step 1202 are those who are properly situated to purchase energy from the seller, such as all being in the geographic area served by the seller, all being connected to a single distribution utility through which the seller can deliver energy, etc.

In various embodiments, the facility uses a variety of approaches to obtain consumption profiles for these buyers. In some embodiments, the facility compiles consumption profiles for the buyers based upon retrieving and digesting their energy bills. In some embodiments, the facility reads the buyer's meters, either directly or through an intermediary, and compiles this information into consumption profiles. In some embodiments, the facility retrieves this information from another authoritative source, such as each buyer's distribution utility or seller.

In various embodiments, the buyer's consumption profiles and seller's target consumption profile are expressed in a variety of ways. For each period included, a profile can indicate either an average rate of energy consumption throughout the period, or a total amount of energy consumed during the period. The periods for which consumption is measured in a profile can differ in various ways, such as being within a different season of the year; being on a different day of the week; being on a week day versus a weekend day; etc. Further, periods can correspond to fractions of days, such as a particular half of a day, a particular quarter of a day, a particular 12th of a day, a particular 24th of a day, 48th of the day, 96th of the day, etc.

In step 1203, the facility identifies a group of buyers whose collective consumption profile best matches the seller's target consumption profile. In step 1204, the facility obtains a quote from the seller for the group identified in step 1203 based upon the group's collective consumption profile. In step 1205, if the quote obtained in step 1204 improves the price for all the buyers in the group relative to the price each is currently paying for energy, then the facility continues in step 1208, else the facility continues in step 1206. In step 1206, the facility temporarily removes from an eligible buyer pool any members of the group for whom the quote obtained in step 1204 does not improve the price it is currently paying. In step 1207, the facility reconstitutes the group, omitting any of the removed buyers. After step 1207, the facility continues to step 1204 to obtain a quote for the reconstituted group.

In step 1208, the facility switches the buyers in the group to buy from the seller. In some cases, the facility may switch some or all the buyers based upon authority earlier delegated to the operator of the facility by the seller. In some cases, the facility uses techniques, such as automated techniques, to contact some or all of the sellers to either seek a contemporaneous delegation of such authority, or have the buyer sign a supply contract naming the seller. After step 1208, these steps conclude.

In some embodiments, where multiple sellers are known or believed to have the same target profile, the facility in step 1204 obtains a quote from each such seller, and proceeds with the seller who quotes the lowest price. In some embodiments, in such cases, the facility conducts a multi-round auction among these sellers, permitting to knowingly bid against one another.

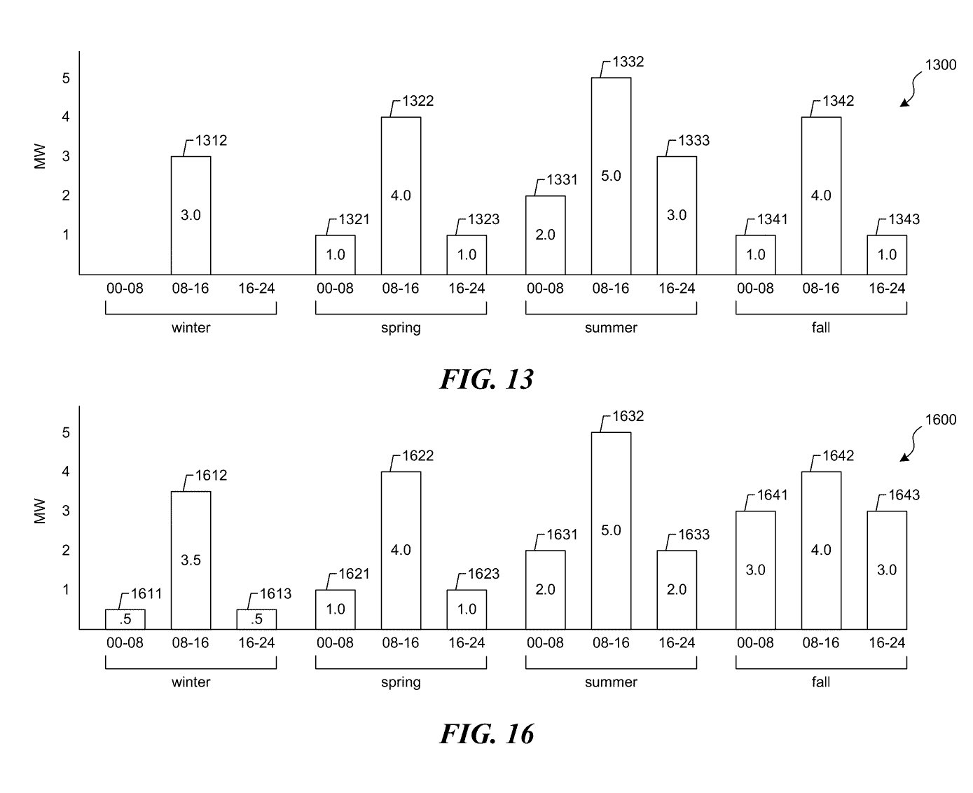

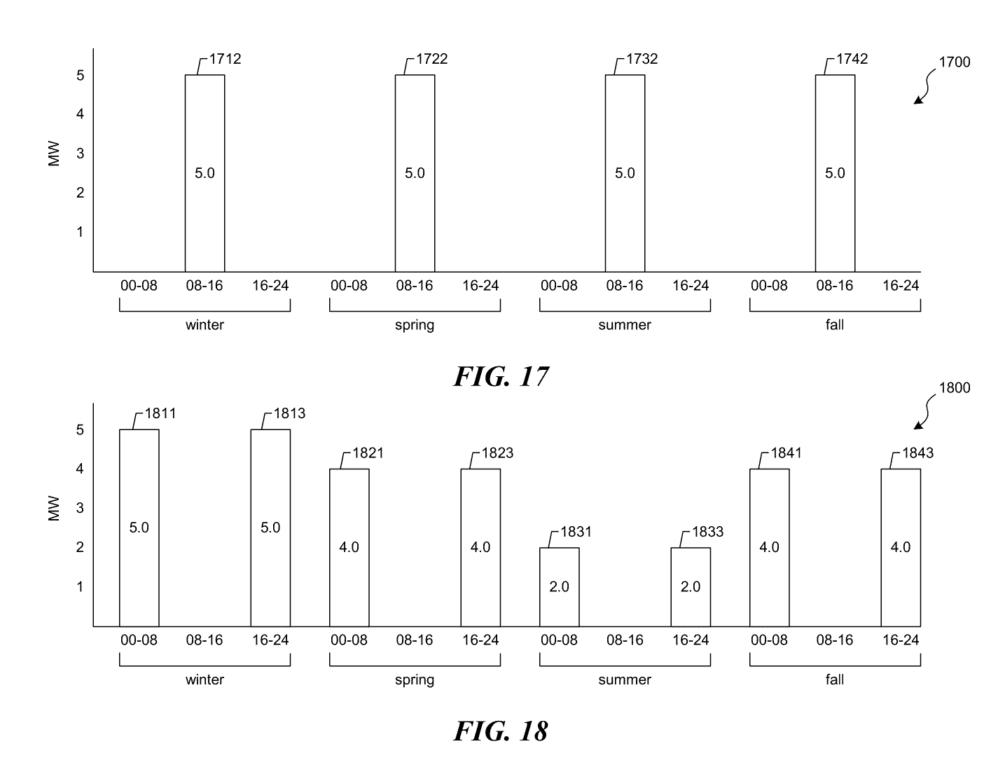

FIGS. 13-16 are energy profile diagrams illustrating the facility's composition of a first sample group of buyers for a first target profile specified by a first seller, while FIGS. 17-20 are energy profile diagrams illustrating a facility's composition of a second sample group of buyers for a second target profile for a second seller.

FIG. 13 is an energy profile diagram showing a target consumption profile specified by a first seller. The profile 1300 is made up of ten measurements out of a total of twelve possible measurements. Measurement 1312 is for the period between 8:00 am. and 4:00 p.m. during winter months. Measurement 1321 is for the period between midnight and 8:00 a.m. on days during spring months, measurement 1322 for the period between 8:00 a.m. and 4:00 p.m. during days in spring months, and measurement 1323 for the period between 4:00 p.m. and midnight on days during spring months. For example, measurement 1312 indicates that the seller wishes to sell energy to a group of buyers whose collective demand between 8:00 a.m. and 4:00 p.m. on winter days averages 3.0 megawatts. The absence of a bar on either side of measurement 1312 indicates that the seller wishes the group to have little or no consumption on winter days between midnight and 8:00 a.m. and between 4:00 p.m. and midnight. As one example, the target consumption profile shown in FIG. 13 may be sought by a seller wishing to sell energy produced by a solar generation facility, whose output peaks in the middle of every day; whose output is highest in the summer and lowest in the winter; and whose output extends further into the early morning and night as the summer solstice approaches.

Those skilled in the art will recognize that energy profiles in a variety of different forms may be substituted for the ones shown herein. For example, profiles may be used that divide days into longer or shorter periods; all on different days of the weeks; are in seasons or portions of the year defined differently; etc.

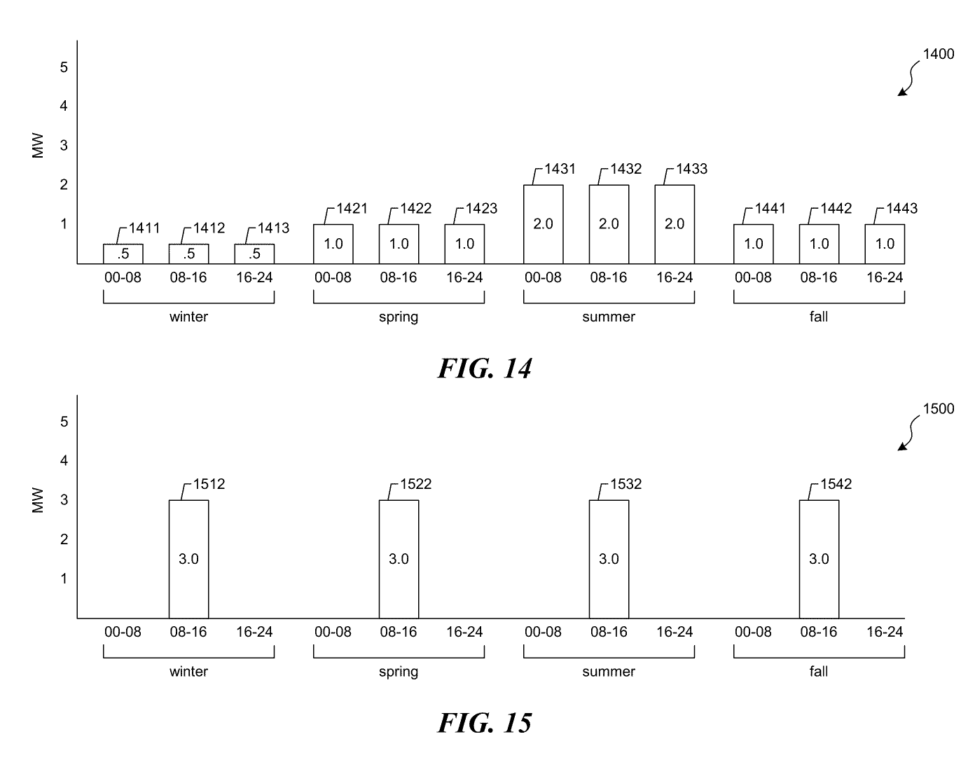

In order to match the seller's target consumption profile shown in FIG. 13, the facility assembles a first group of buyers made up of a first buyer whose consumption profile is shown in FIG. 14, and a second buyer whose consumption profile is shown in FIG. 15.

FIG. 14 is an energy profile diagram showing the consumption profile of a first buyer included in the first group. The profile 1400 is consistent throughout the day; highest in the summer; and lowest in the winter. For example, this profile may correspond to a buyer who operates a refrigerated food storage warehouse whose substantial thermal insulation prevents significant intraday fluctuations in energy consumption, but nonetheless must expend more energy to maintain cool temperatures during longer periods of warm weather.

FIG. 15 is an energy profile diagram showing the consumption profile of a second buyer included in the first group. The consumption profile 1500 reflects consumption fully focused on the middle third of the day, which is invariant among seasons. This profile may, for example, correspond to an office building that consumes all of its energy during typical business hours.

FIG. 16 is an energy profile diagram showing the collective consumption profile of the first and second buyers, i.e., the first group of buyers. This profile 1600 is determined by the facility by summing the energy measurement for the first and second buyers for each of the twelve shown periods. It can be seen by comparing buyers' collective consumption profile 1600 to seller's target consumption profile 1300 that the buyers' profile matches the seller's target profile exactly in the spring, summer, and fall seasons, and slightly exceeds the seller's target profile during each time period in the winter season. If this result is better than the result that would be produced from any other group of buyers considered by the facility, then the facility proceeds to seek a quote from the seller for this group based upon the group's collective consumption profile 1600.

FIGS. 17-19 are energy profile diagrams showing the consumption profile for three buyers assembled as a second group by the facility for a second seller that is known or believed to seek groups with a flat collective consumption profile.

FIG. 17 is an energy profile diagram showing the consumption profile for a first buyer in the second group. The profile 1700 consumes energy exclusively during the middle third of the day, consistently across all four seasons. For example, this first buyer may be a group of one or more office buildings.

FIG. 18 is an energy profile diagram showing a consumption profile for a second buyer in the second group. This profile 1800 is highest in the winter, lowest in the summer, and divided equally between the first and last periods of each day. For example, this second buyer may be a neighborhood association that consumes energy solely to power overnight exterior lighting, which is needed for longer fractions of the first and last thirds of the day in the winter than in the summer.

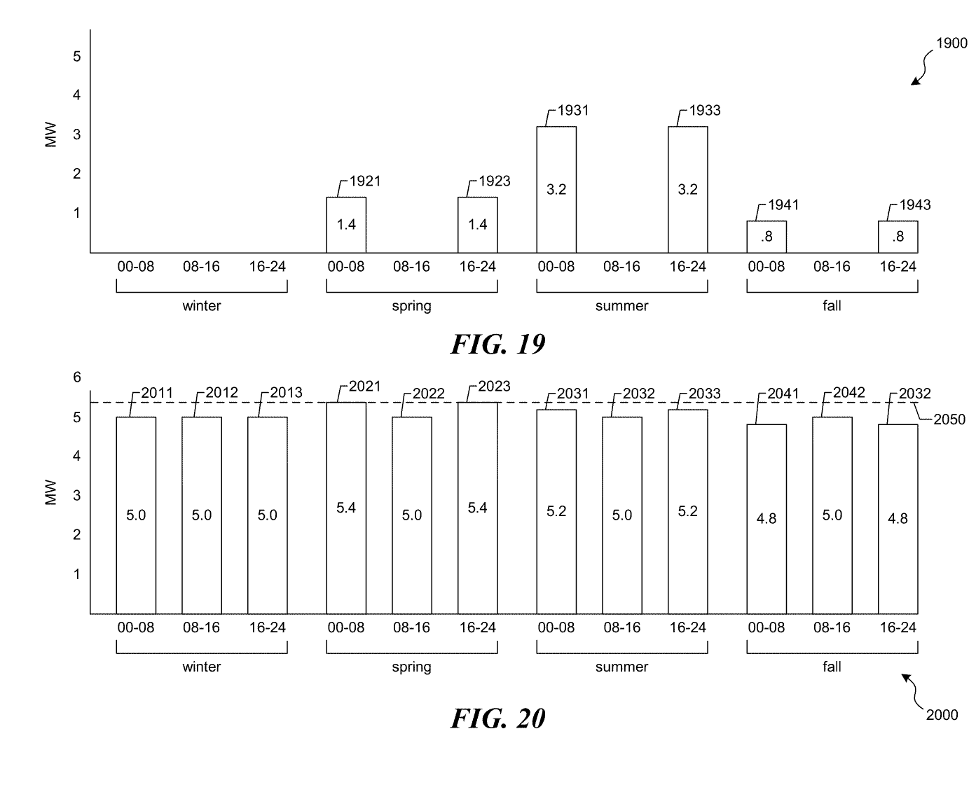

FIG. 19 is an energy profile diagram showing the consumption profile for a third buyer in the second group. This profile 1900 is concentrated in the summer season, to the exclusion of the winter season, and is divided equally between the first and last thirds of each day. For example, this third buyer may be a driving range, all of whose energy consumption is to power bright lights illuminating the range during times when the range is open, but would otherwise be dark. Because the range is open for the longest hours during the summer, consumption is concentrated there.

FIG. 20 is an energy profile diagram showing the collective consumption profile for the second group of buyers. The profile 2000 shows an almost uniform consumption of energy across the three members of the second group. Measurements 2021 and 2023 are the highest at 5.4 megawatts, while measurements 2041 and 2043 are the lowest each at 4.8 megawatts.

One measure of the uniformity of an energy profile is load factor, defined to be average consumption rate divided by peak consumption rate. The load factor for the collective consumption profile 2000 for the second group is 93.8%, determined by dividing the average consumption rate of 5.067 megawatts by the peak consumption rate of 5.4 megawatts. If this load factor is higher than the load factor for any other group of buyers considered by the facility, then the facility seeks a quote from the seller for this group based upon the collective consumption profile shown in FIG. 20.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1-4. (canceled)

5. A method in a computing system for generating an energy cost model, comprising:
for a plurality of energy customers:
obtaining at least one energy bill issued to the energy customer by an energy utility that is delivering energy to the energy customer purchased from an energy supplier;
for each of the obtained energy bills:
for each of a plurality of charges:
extracting the charge from the obtained energy bill, the extracted charge comprising:
a description for the charge,
a quantity for the charge,
a rate for the charge, and
an amount for the charge;
determining, based upon the description, whether the extracted charge constitute a supply charge or distribution charge;
for extracted charges determined to be supply charges, attributing the extracted charge to the energy supplier for the energy bill; and
for extracted charges determined to be distribution charges, attributing the extracted charge to the energy utility for the energy bill;
wherein, for each of a plurality of energy suppliers, the extracted charges attributed to the energy supplier constitute an energy supply cost model for energy purchased from the energy supplier,
and wherein, for each of a plurality of energy utilities, the extracted charges attributed to the energy utility constitute an energy distribution cost model for energy delivered by the energy utility.

6. The method of claim 5, further comprising, for each of at least a portion of the obtained bills, the extracting comprises performing optical character recognition on one or more images of the obtained bill.

7. The method of claim 5 wherein the collected information comprises information about the cost of each of a plurality of constituent energy charges.

8. The method of claim 7 wherein the plurality of constituent energy charges includes supply energy charges.

9. The method of claim 7 wherein the plurality of constituent energy charges includes distribution energy charges.

10. The method of claim 7 wherein the plurality of constituent energy charges includes energy tax energy charges.

11. The method of claim 5 wherein the energy costs predicted by the model comprise energy costs for electricity.

12. The method of claim 5 wherein the energy costs predicted by the model comprise energy costs for natural gas.

13. The method of claim 5 wherein the energy costs predicted by the model comprise energy costs for hydrogen.

14. The method of claim 5 wherein the energy costs predicted by the model comprise energy costs for heating oil.

15. The method of claim 5 wherein the energy costs predicted by the model comprise energy costs for aviation fuel.

16. The method of claim 5 wherein the energy costs predicted by the model comprise energy costs for propane.

17. The method of claim 5, further comprising, for a selected energy customer to whom energy purchased from a selected energy supplier is delivered by a selected energy utility:
applying the energy supply cost model for energy purchased from the selected energy supplier to predict an energy supply cost for a selected level of consumption by the selected energy customer for a selected period of time; and
applying the energy distribution cost model for energy delivered by the selected energy supplier to predict an energy distribution cost for the selected level of consumption by the selected energy customer for the selected period of time.

18. The method of claim 17 wherein the selected period of time is a future period of time.

19. The method of claim 17 wherein the selected period of time is a past period of time corresponding to a baling period for which energy supplier has generated a bill for the selected energy customer specifying a charged energy cost, the method further comprising comparing the predicted energy cost to the charged energy cost to assess the correctness of the bill.

20. The method of claim 5, further comprising:
using at least a portion of one of the charges extracted from energy bills issued to energy customers to determine an amount to be paid by selected energy supplier; and
verifying whether an amount paid by the selected energy supplier matches the determined amount to be paid.

21. The method of claim 5, further comprising:
using at least a portion of one of the charges extracted from energy bills issued to a selected one of the plurality of energy customers to determine an amount to be paid by the selected energy customer; and
causing the selected energy customer to be charged the determined amount.

22. A computer-readable medium storing an energy cost model data structure, the data structure comprising:
for each of a plurality of energy suppliers:
for each of a plurality of energy supply charge types:
information representing at least one observation, each represented observation (a) having been extracted from an energy bill issued to an energy buyer who is a customer of the energy supplier, and (b) reflecting a rate charged to the energy customer for the energy supply charge type,
such that contents of the data structure are usable to estimate, for each of the energy supply charge types, the amount that would be charged to a selected buyer who is a customer of a selected energy supplier by the selected energy supplier for a selected level of consumption by the selected buyer.

23. The computer-readable medium of claim 22, the data structure further comprising:
for each of a plurality of energy utilities:
for each of a plurality of energy distribution charge types:
information representing at least one observation, each represented observation (a) having been extracted from an energy bill issued to an energy buyer who is a customer of the energy utility, and (b) reflecting a rate charged to the energy customer for the energy distribution charge type,
such that contents of the data structure are usable to estimate, for each of the energy distribution charge types, the amount that would be charged to a selected buyer who is a customer of a selected energy utility by the selected energy utility for a selected level of consumption by the selected buyer.

24. A computer-readable medium having contents configured to cause a computing system to perform a method for estimating a cost for a selected level of energy consumption by a selected energy customer served by a selected energy utility, the method comprising:
applying an energy distribution cost model to predict, for each of one or more energy distribution charges, an amount that the selected energy customer would be charged by the selected energy utility based upon the selected level of energy consumption;
identifying an energy supplier; and
applying an energy supply cost model to predict, for each of one or more energy supply charges, an amount that the selected energy customer would be charged by the identified energy supplier based upon the selected level of energy consumption.

25. The computer-readable medium of claim 24, the method further comprising:
extracting the selected level of energy consumption from an indication in an energy bill prepared for the selected energy customer of an actual amount of energy purchased by the energy customer from the identified energy supplier during a selected past period of time;
for each of the energy distribution charges;
extracting from the energy bill an actual amount charged for the energy distribution charge;
determining whether the extracted actual amount charged for the energy distribution charge matches the predicted amount for the energy distribution charge;
for each of the energy supply charges,
extracting from the energy bill an actual amount charged for the energy supply charge;
determining whether the extracted actual amount charged for the energy supply charge matches the predicted amount for the energy supply charge;
where (1) for each of the energy distribution charges, it is determined that the extracted actual amount charged for the energy distribution charge matches the predicted amount for the energy distribution charge, and (2) for each of the energy supply charges, it is determined that the extracted actual amount charged for the energy supply charge matches the predicted amount for the energy supply charge, storing an indication that the energy bill is proper.

26. The computer-readable medium of claim 25, the method further comprising:
for each of the energy distribution charges:
extracting from the energy bill a rate charged for the energy distribution charge;
for each of the energy supply charges:
extracting from the energy bill a rate charged for the energy supply charge;
where (1) for each of the energy distribution charges, it is determined that the extracted actual amount charged for the energy distribution charge matches the predicted amount for the energy distribution charge, and (2) for each of the energy supply charges, it is determined that the extracted actual amount charged for the energy supply charge matches the predicted amount for the energy supply charge:
adapting the energy distribution cost model based upon the rates charged for energy distribution charges extracted from the energy bill; and
adapting the energy supply cost model based upon the rates charged for energy supply charges extracted from the energy bill.

27. The computer-readable medium of claim 25, the method further comprising:
where (1) for any of the energy distribution charges, it is determined that the extracted actual amount charged for the energy distribution charge does not match the predicted amount for the energy distribution charge, or (2) for any of the energy supply charges, it is determined that the extracted actual amount charged for the energy supply charge does not match the predicted amount for the energy supply charge, storing an indication that the energy bill is improper.

28. The computer-readable medium of claim 25, the method further comprising:
where, for any of the energy distribution charges, it is determined that the extracted actual amount charged for the energy distribution charge does not match the predicted amount for the energy distribution charge, storing an indication that the energy distribution cost model has failed to accurately predict an energy distribution charge amount for the selected energy utility.

29. The computer-readable medium of claim 25, the method further comprising:
where, for any of the energy supply charges, it is determined that the extracted actual amount charged for the energy supply charge does not match the predicted amount for the energy supply charge, storing an indication that the energy supply cost model has failed to accurately predict in energy supply charge amount for the identified energy supplier.

30. The computer-readable medium of claim 24 wherein the selected period of time is a future period of time corresponding to one or more consecutive energy billing cycles.

31-68. (canceled)
